(19) United States
(12) Patent Application Publication
(10) Pub. No.: US 2014/0102478 A1
(43) Pub. Date: Apr. 17, 2014

(54) METHOD AND SYSTEM FOR CLEANING SHEET- OR PLATE-SHAPED OBJECTS

(71) Applicant: Li-Tec Battery GmbH, Kamenz (DE)

(72) Inventors: Claus-Rupert Hohenthanner, Hanau (DE); Steffen Legner, Ellwangen (DE)

(73) Assignee: Li-Tec Battery GmbH, Kamenz (DE)

(21) Appl. No.: 14/137,634

(22) Filed: Dec. 20, 2013

Related U.S. Application Data
(63) Continuation of application No. 13/988,230.

(30) Foreign Application Priority Data
Nov. 17, 2010 (DE) 10 2010 051 668.6

(51) Int. Cl. B08B 1/02; B08B 1/00

(52) U.S. Cl. CPC B08B 1/02; B08B 1/002
USPC 134/9; 15/77

(57) ABSTRACT

The invention describes a system for cleaning sheet- or plate-like objects (10), in particular for cleaning electrodes and/or separators for constructing an electrochemical energy storage means or cleaning parts of such electrodes or separators, wherein the sheet- or plate-like objects (10) have a first object side (11) and a second object side (12), which is situated opposite the first object side, and at least one side surface which connects the first object side (11) and the second object side (12). The cleaning system (50) has: a first conveyor belt (1) for moving the object (10) to a first cleaning apparatus (21), wherein the first conveyor belt (1) is arranged and designed in such a way that it holds the object (10) such that the second object side (11) faces the first conveyor belt (1); the first cleaning apparatus (21) which is arranged and designed in such a way that it can clean the first object side (12) and at least one side surface of the object (10) on the first conveyor belt (1); a second conveyor belt (2) for taking the object (10) from the first conveyor belt (1) and moving the object (10) to a second cleaning apparatus (22), wherein the second conveyor belt (1) is arranged and configured in such a way that it holds the object (10) such that the first object side (12) faces the second conveyor belt (1); and the second cleaning apparatus (22) which is arranged and designed in such a way that it can clean the second object side (11) and at least one side surface of the object (10) on the second conveyor belt (2).

### CROSS-REFERENCE TO RELATED APPLICATIONS

This application is a continuation of U.S. patent application Ser. No. 13/988,230, filed May 17, 2013, which is a 35 U.S.C. §371 National Stage Application of International Application No. PCT/EP2011/005610, filed Nov. 8, 2011, which claims priority to DE 10 2010 051 668.6, filed Nov. 17, 2010. International Application No. PCT/EP2011/005610 is incorporated herein by reference in its entirety.

### DESCRIPTION

The present invention relates to a method and a system for cleaning sheet- or plate-shaped objects, particularly for cleaning electrodes and/or separators for constructing an electrochemical energy storage or parts of such electrodes or separators.

Batteries (primary storages) and rechargeable batteries (secondary storages) are known as electrochemical energy storages, which are constructed from one or a plurality of storage cells, in which by applying a charging current, electrical energy is converted into chemical energy in an electrochemical charging reaction between a cathode and an anode in or between an electrolyte and is stored as such and in which when connecting an electrical consumer, chemical energy is converted into electrical energy in an electrochemical discharging reaction. In this case, primary storages are generally only charged once and discarded after the discharging thereof, whilst secondary storages allow a plurality of (from a few 100 to more than 10,000) cycles of charging and discharging. In this context, it is to be noted that particularly in the motor vehicle sector, rechargeable batteries are also termed batteries.

An “electrochemical energy storage” should be understood in the present to mean any type of energy storage from which electrical energy can be drawn, wherein an electrochemical reaction proceeds in the interior of the energy storage. The term comprises energy storages of all types, particularly primary batteries and secondary batteries. The electrochemical energy storage apparatus has at least one electrochemical cell, preferably a plurality of electrochemical cells. The plurality of electrochemical cells can be connected in parallel for storing a greater charge quantity or in series for achieving a desired operating voltage or form a combination of parallel and series connection.

In this case, an “electrochemical cell” is to be understood as meaning an apparatus which is used for supplying electrical energy, wherein the energy is stored in chemical form. In the case of rechargeable secondary batteries, the cell is also constructed in order to receive electrical energy, convert the same into chemical energy and store it. The shape (i.e. in particular the size and the geometry) of an electrochemical cell can be chosen as a function of the available space. Preferably, the electrochemical cell is essentially prismatically or cylindrically constructed. The present invention can advantageously be used in particular for electrochemical cells which are termed pouch cells or coffee bag cells, without it being the case that the electrochemical cell of the present invention should be limited to this application.

Such an electrochemical cell conventionally has an electrode stack which is enclosed at least to some extent by a jacket. In this context, an “electrode stack” should be understood to mean an arrangement of at least two electrodes and an electrolyte arranged therebetween. The electrolyte can to some extent be accommodated by a separator, wherein the separator then separates the electrodes. Preferably, the electrode stack has a plurality of layers of electrodes and separators, wherein the electrodes of the same polarity are in each case preferably electrically connected to one another, in particular connected in parallel. The electrodes are for example constructed in a plate-shaped or film-like manner and are preferably arranged essentially parallel to one another (prismatic energy storage cells). The electrode stack can also be wound and have an essentially cylindrical shape (cylindrical energy storage cells). The term “electrode stack” should also include electrode windings of this type. The electrode stack can have lithium or another alkaline metal also in ionic form.

The electrodes and the separators are required in very large numbers, for which reason there is a requirement for high-quality, effective and cost-effective assembly methods. When assembling the electrodes and separators, it is to be noted that these components are cleaned before assembling the electrode stack or cells. In this context, account is also to be taken of the fact that these components are conventionally produced from a strip material by e.g. cutting or sawing wherein a dust is created, which to some extent also remains adhered on the components.

It is therefore an object of the present invention to create an improved method and an improved system for cleaning sheet- or plate-shaped objects.

This object is achieved by means of a method and a system respectively for cleaning sheet- or plate-shaped objects according to one of the independent claims. Advantageous configurations and developments are the subject of the dependent claims.

The method according to the invention is used for cleaning sheet- or plate-shaped objects, particularly for cleaning electrodes and/or separators for constructing an electrochemical energy storage or parts of such electrodes or separators, wherein the sheet- or plate-shaped objects have a first object side and a second object side opposite the first object side and at least one side surface connecting the first and the second object sides. In the method, initially at least one object is arranged on a first transport belt, preferably a first vacuum belt in such a manner that the second object side faces the first transport belt (step S1). Then, the object is moved with the first transport belt to a first cleaning apparatus, preferably a first cleaning a first cleaning device (step S2), by means of which the first object side and preferably at least one side surface of the object are cleaned on the first transport belt (step S3). Subsequently, the object is handed over from the first transport belt to a second transport belt, preferably to a second vacuum belt, in such a manner that the first object side faces the second transport belt (step S4). The second transport belt then moves the object to a second cleaning apparatus (step S5), by means of which the second object side and preferably at least one side surface of the object are cleaned on the second transport belt (step S6).

Using this method, the objects can be cleaned very effectively and thoroughly on both object sides thereof and on both side surfaces. This method is additionally suitable for continuous cleaning methods in continuous production lines. The method is also suitable for cleaning a very large number of objects.

The method according to the invention can advantageously also be used for cleaning objects with low dimensional stability and/or with small thickness dimensions. Thus, it offers particular advantages for cleaning electrodes or separators for constructing electrochemical energy storages.

In the context of this invention, “sheet- or plate-shaped object” should be understood to mean an essentially flat object, preferably a thin flat object. A flat object is in this case an object, the dimensions of which are substantially smaller in a direction perpendicular to the surface thereof (also termed the thickness direction) than the dimensions of the largest distances which lie completely within the surface.

The first and the second object sides in each case form the surface of a flat object of this type, wherein the first object side and the second object side preferably run parallel to one another without it being the case that the invention should be limited to this design variant. The at least one side surface, which connects the first and the second object sides to one another, determines the thickness dimension of the flat object. The side area in this case runs essentially perpendicularly to the first and to the second object side, without it being the case that the invention should be limited to this design variant. The first and second object sides can fundamentally have any desired shape, preferably the first and the second object sides are chosen to be essentially rectangular in each case; in this case, the object as a whole has four side surfaces, wherein adjacent side surfaces are arranged essentially at right angles to one another. The thickness dimension of the objects can fundamentally be chosen as desired, it preferably ranges from film thickness through to plate thickness. The first object side of the object can also be termed as object upper side and the second object side of the object can also be termed as object underside or vice versa.

In the sense of the invention, a transport belt is to be understood as meaning a belt for transporting the objects, with which the objects are transported and preferably adhere by means of vacuum, mechanically, electrostatically or magnetically. Preferably, the transport belt is a vacuum belt, on which the objects adhere by means of vacuum. Conventional components of a typical vacuum belt are a conveyor, at least one vacuum channel, a conveyor belt and at least one vacuum pump.

In the sense of the invention, a “cleaning apparatus” is understood to mean an apparatus which has a functional unit which is configured and arranged for cleaning the surfaces of the objects, i.e. the respectively exposed first or second object side and at least one side surface of the object. In the cleaning process by means of such a cleaning apparatus, particles adhering on the object in particular should be loosened and removed. For the cleaning process, the cleaning apparatus preferably does not use any electrically conductive parts, in order to prevent brush particles from being able for example to get into the electrochemical storage cell and there cause a short circuit. The first and second cleaning apparatuses are preferably two different mutually separate apparatuses, but they may however alternatively also be one and the same apparatus.

In an advantageous embodiment of the invention, the object is arranged on the first and/or the second transport belt in such a manner that at least one side surface of the object is orientated at an angle different from 0 degrees and from 90 degrees, preferably at an angle in the range from approximately 30 to 45 degrees relatively to the running direction of the first or of the second transport belt. In the case of an object with essentially rectangular first and second object sides, preferably all four side surfaces of the object are orientated at an angle of approximately 45 degrees relatively to the running direction of the first or second conveyor belt in each case. By means of this measure, the side surfaces of the object can be better and more thoroughly cleaned by the first or the second cleaning apparatus, in particular also in the case of a continuous method.

In an advantageous embodiment of the invention, the object is cleaned in a continuous method in step S3 and/or in step S6. As a result, the duration of the cleaning method can be shortened.

In an advantageous embodiment of the invention, the object is brushed in a continuous method in step S3 and/or in step S6 on the first or the second transport belt with at least one rotating brush for loosening adhering particles. One advantage of this embodiment lies in the fact that the cleaning of the object can be carried out quickly and thoroughly.

In an advantageous embodiment of the invention, in step S3 and/or step S6, particles are loosened from the object on the first or second transport belt by means of ultrasonic pulses. One advantage of this embodiment lies in the fact that the cleaning of the object can be carried out in a particularly gentle manner and problems with electrostatic charging can be reduced.

In an advantageous embodiment of the invention, in step S3 and/or step S6, the particles loosened from the object are conveyed away by means of an air flow. An advantage of this embodiment lies in the gentle and thorough cleaning of the object.

In an advantageous embodiment of the invention, the object is electrostatically discharged on the first transport belt and/or on the second transport belt. The electrostatic discharging can take place before, during and/or after the cleaning on the respective transport belt. One advantage of this embodiment lies in the fact that damages to the object and/or a unit to be constructed using the object due to electrostatic charges can be prevented.

In an advantageous embodiment of the invention, after step S6, in a step S7 the object is handed over from the second transport belt to a third transport belt, wherein the second object side faces the third transport belt. With the aid of the third transport belt, the object can preferably be fed to a further cleaning method or transported further. In an advantageous embodiment of the invention, in step S4 and/or in step S7 the object is handed over between the two transport belts with constant orientation relative to the running direction of the first or the second transport belt. An advantage of this embodiment lies in the simple process control of the cleaning method.

The system according to the invention is used for cleaning sheet- or plate-shaped objects, particularly for cleaning electrodes and/or separators for constructing an electrochemical energy storage or parts of such electrodes or separators, wherein the sheet- or plate-shaped objects have a first object side and a second object side opposite the first object side and at least one side surface connecting the first and the second object sides. The cleaning system has: a first transport belt for moving the object to a first cleaning apparatus, wherein the first transport belt is arranged and configured in such a manner that it accommodates the object in such a manner that the second object side faces the first transport belt; the first cleaning apparatus, which is arranged and configured in such a manner that it can clean the first object side and at least one side surface of the object on the first transport belt; a second transport belt for handing over the object from the first transport belt and moving the object to a second cleaning apparatus, wherein the second transport belt is arranged and configured in such a manner that it accommodates the object in such a manner that the first object side faces the second transport belt; and the second cleaning apparatus, which is arranged and configured in such a manner that it can clean the second object side and at least one side surface of the object on the second transport belt.

With regards to the advantages of this cleaning system and the terms used, the statements made above in connection with the cleaning method according to the invention apply in a corresponding manner.

In an advantageous embodiment of the invention, the first and/or the second cleaning apparatus have at least one rotating brush in each case.

In this embodiment, the first and/or the second cleaning apparatus preferably have at least one brush in each case, which is selected from a group which contains conical brushes, spirally running brushes, roller brushes, round brushes, cup brushes and bevel brushes.

In this embodiment, the first and/or the second cleaning apparatus preferably have in each case at least two brushes which are arranged parallel or at an angle with respect to one another and are orientated parallel or at an angle to the running direction of the first or of the second transport belt.

In an advantageous embodiment of the invention, the first and/or the second cleaning apparatus have at least one ultrasonic unit for generating ultrasonic pulses directed onto the object.

In an advantageous embodiment of the invention, the first and/or the second cleaning apparatus have an air flow unit for generating an air flow for conveying away the particles loosened from the object.

In an advantageous embodiment of the invention, a suction direction of the first transport belt is chosen to be opposite to a suction direction of the second transport belt. An advantage of this embodiment is the possibility of a compact construction of the cleaning system.

In an advantageous embodiment of the invention, the first transport belt and the second transport belt can be arranged such that the running directions thereof overlap one another, wherein the dimension of the overlapping preferably corresponds at least to the size of an object in the running direction of the first or second transport belt. An advantage of this embodiment is the possibility of a compact construction of the cleaning system.

In an advantageous embodiment of the invention, a first electrostatic discharge apparatus, which is arranged on the first transport belt and/or the first cleaning apparatus, and/or a second electrostatic discharge apparatus, which is arranged on the second transport belt and/or the second cleaning apparatus, are provided.

In an advantageous embodiment of the invention, the first and/or second electrostatic discharge apparatuses have a discharge functional unit which is selected from a group which contains a metal roller, a roller with conductive surface, a discharge rod, a curtain with electrically conductive constituents and possibly further discharge functional units.

In an advantageous embodiment of the invention, at least one third transport belt is provided for handing over the object from the second transport belt.

The present invention also relates to an electric cell for an electrochemical storage apparatus with electrodes or separators which has been cleaned according to a previously mentioned cleaning method and/or produced with the aid of a previously mentioned cleaning system.

Further advantages, features and application possibilities of the present invention result from the following description in connection with the drawings. In the figures:

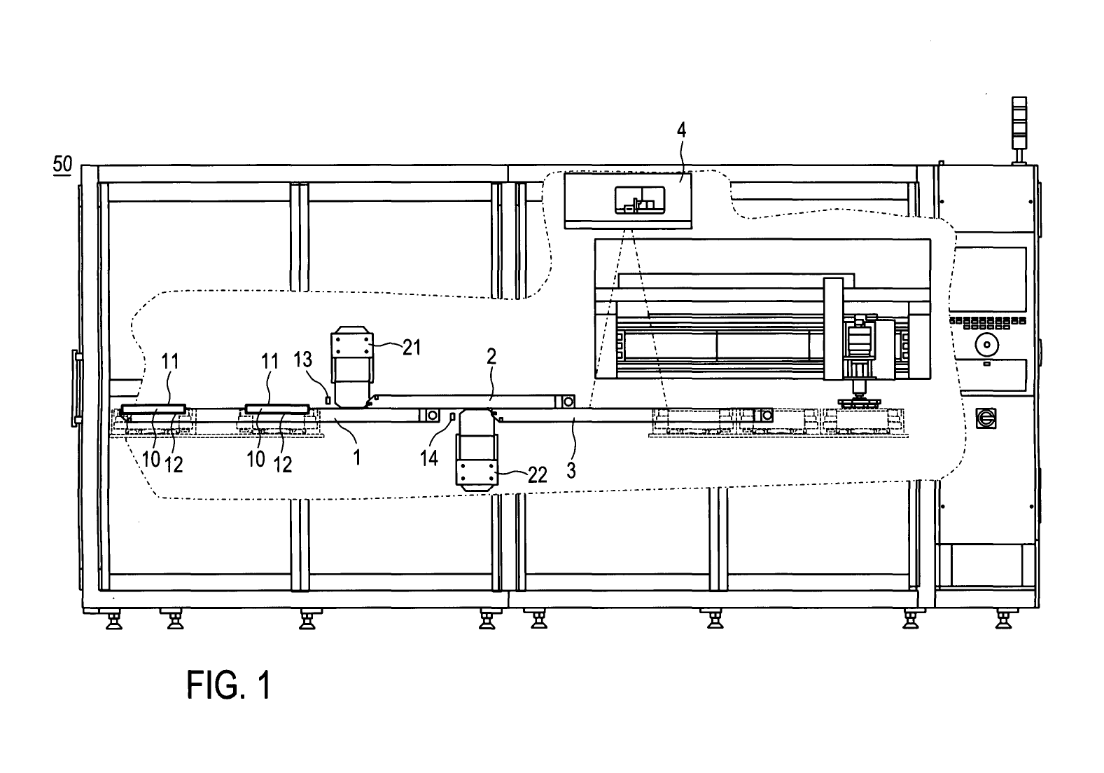

FIG. 1 shows a cross-sectional illustration of a cleaning system according to a preferred embodiment of the invention;

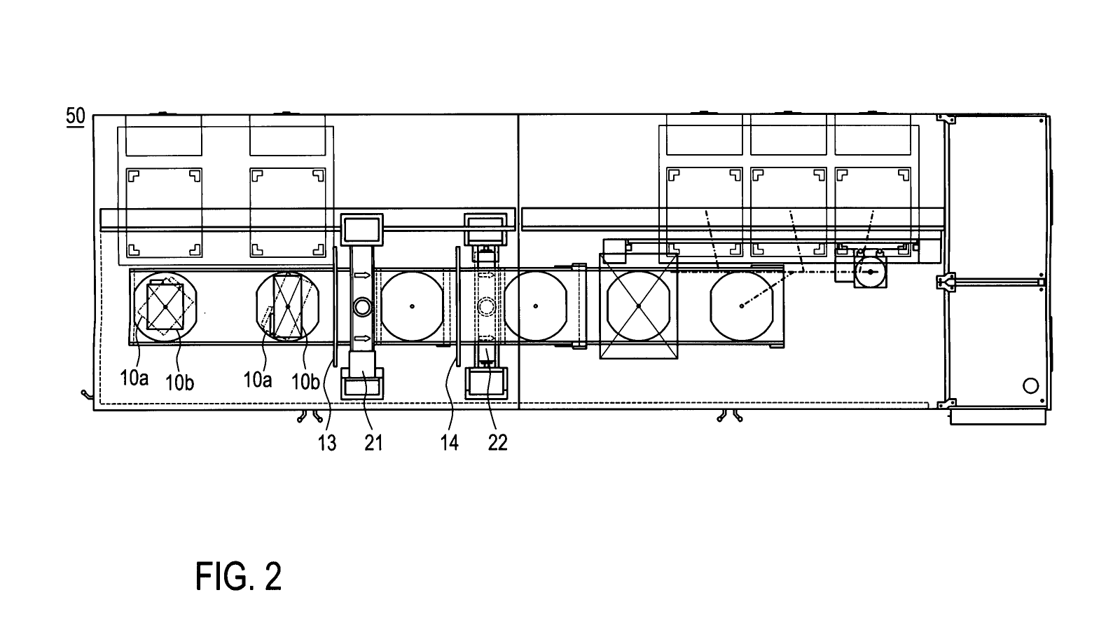

FIG. 2 shows a schematic plan view of the cleaning system in FIG. 1;

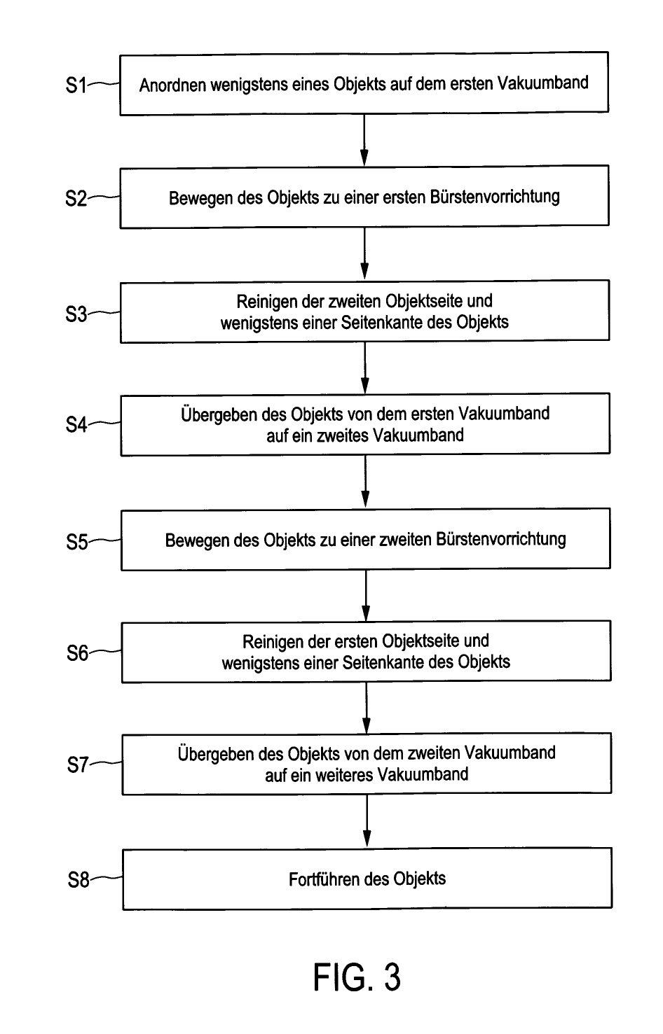

FIG. 3 shows a flow diagram of a cleaning method according to the present invention;

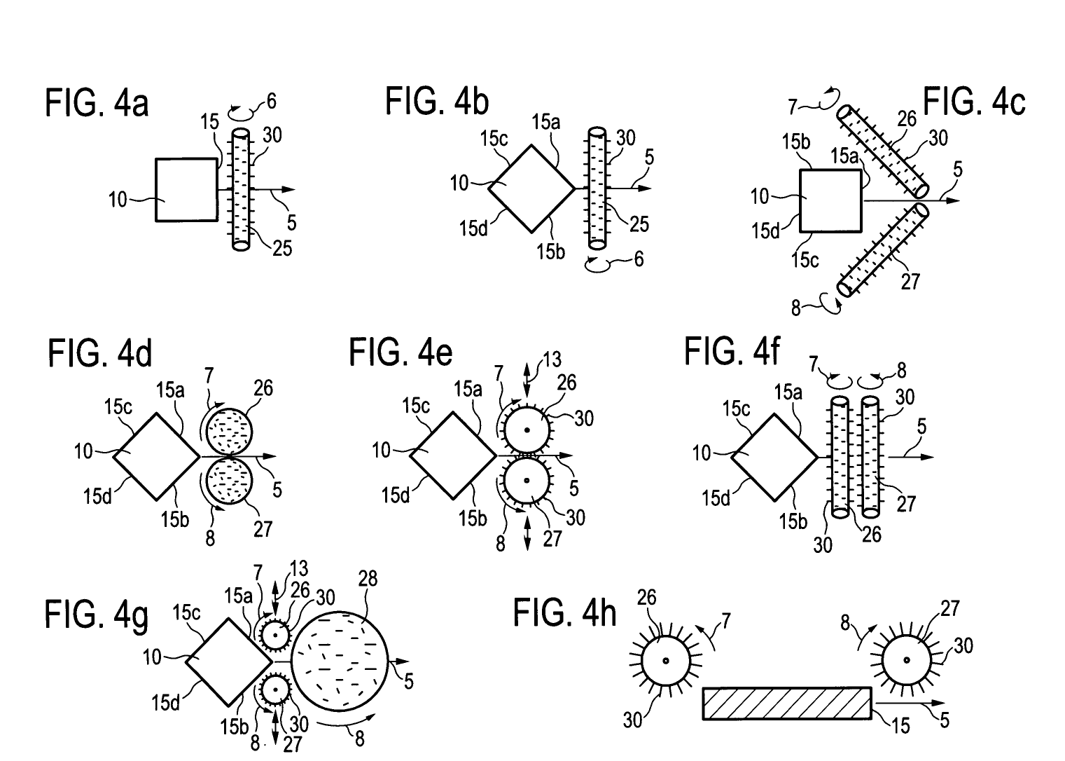

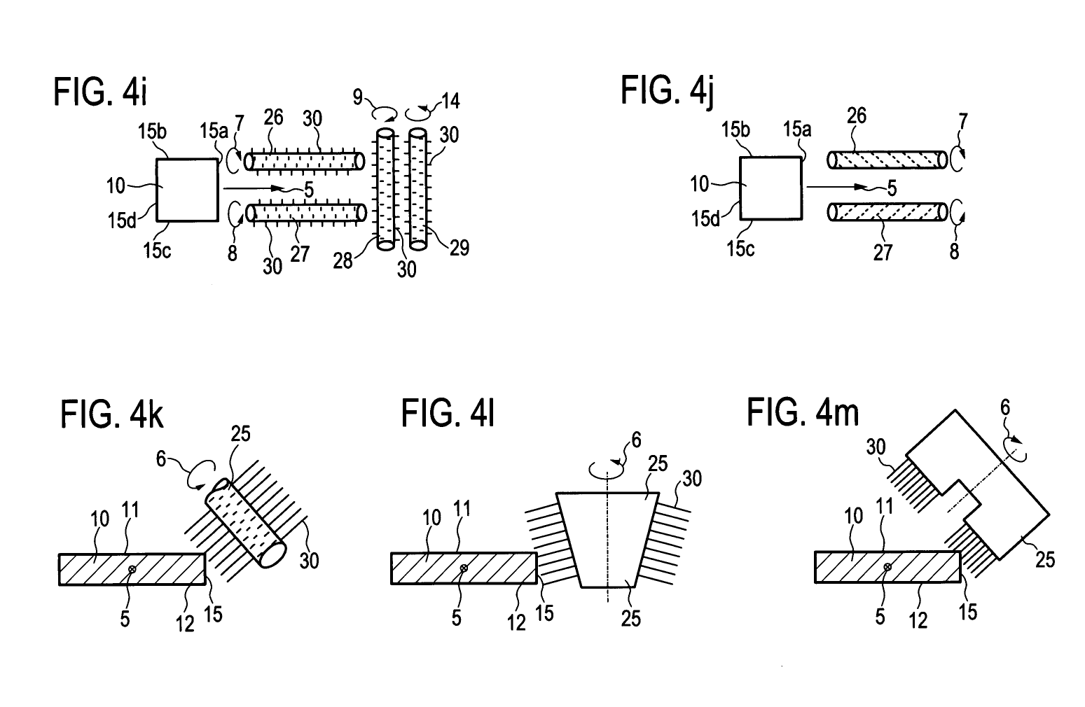

FIG. 4a shows a schematic illustration for arranging the cleaning apparatus in relation to the running direction and arrangement of the electrodes according to a first embodiment;

FIG. 4b shows a schematic illustration for arranging the cleaning apparatus in relation to the running direction and arrangement of the electrodes according to a second embodiment;

FIG. 4c shows a schematic illustration for arranging the cleaning apparatus in relation to the running direction and arrangement of the electrodes according to a third embodiment;

FIG. 4d shows a schematic illustration for arranging the cleaning apparatus in relation to the running direction and arrangement of the electrodes according to a fourth embodiment;

FIG. 4e shows a schematic illustration for arranging the cleaning apparatus in relation to the running direction and arrangement of the electrodes according to a fifth embodiment;

FIG. 4f shows a schematic illustration for arranging the cleaning apparatus in relation to the running direction and arrangement of the electrodes according to a sixth embodiment;

FIG. 4g shows a schematic illustration for arranging the cleaning apparatus in relation to the running direction and arrangement of the electrodes according to a seventh embodiment;

FIG. 4h shows a schematic illustration for arranging the cleaning apparatus in relation to the running direction and arrangement of the electrodes according to an eighth embodiment;

FIG. 4i shows a schematic illustration for arranging the cleaning apparatus in relation to the running direction and arrangement of the electrodes according to a ninth embodiment;

FIG. 4j shows a schematic illustration for arranging the cleaning apparatus in relation to the running direction and arrangement of the electrodes according to a tenth embodiment;

FIG. 4k shows a schematic cross-sectional illustration for arranging the cleaning apparatus in relation to the running direction and arrangement of the electrodes according to an eleventh embodiment;

FIG. 4l shows a schematic cross-sectional illustration for arranging the cleaning apparatus in relation to the running direction and arrangement of the electrodes according to a twelfth embodiment and

FIG. 4m shows a schematic cross-sectional illustration for arranging the cleaning apparatus in relation to the running direction and arrangement of the electrodes according to a thirteenth embodiment.

The present invention is described in the following with the example of the cleaning of electrodes for an electrochemical energy storage.

FIG. 1 shows a schematic illustration of a cleaning system 50 according to the present invention, and FIG. 2 shows a schematic plan view onto the cleaning system 50. The cleaning system 50 has a first transport belt 1 for electrodes 10 with an upper side (first object side) 11 and an underside (second object side) 12, a first cleaning apparatus 21 arranged on this first transport belt 1, a first discharge apparatus 13 arranged upstream of the first cleaning apparatus 21 in the running direction on the first transport belt 1, a second transport belt 2, a second cleaning apparatus 22 arranged on this second transport belt 2, a second discharge apparatus 14 arranged upstream of the second cleaning apparatus 22 in the running direction on the second transport belt 2, and a third transport belt 3 for guiding the electrodes 10 further.

The electrodes 10 are arranged on the first transport belt 1 by means of the underside 12 thereof in the direction of the transport belt 1. As FIG. 1 illustrates, the first and the second transport belts 1, 2 are advantageously arranged in such a manner that the suction direction of the first transport belt 1 is chosen to be opposite to the suction direction of the second transport belt 2 and that the first and the second transport belts 1, 2 are arranged such that their running directions overlap one another. The degree of overlapping can preferably at least correspond in this case to the size of an electrode 10 in the running direction of the first or second transport belt 1, 2. With this configuration of the first and the second transport belts 1, 2, the electrodes 10 can be handed over from the first transport belt 1 to the second transport belt 2 in such a manner that the electrodes 10 are arranged by means of the upper side 11 thereof in the direction of the second transport belt 2, without the electrodes 10 having to be rotated during this handing over. The third transport belt 3 adjoins the second transport belt 2 in a similar manner.

For better representability, the electrodes 10 in FIGS. 1 and 2 are not shown to scale and not in the plane between the vacuum belts 1, 3 on the one hand and the transport belt 2 on the other hand.

The first cleaning apparatus 21 on the first transport belt and the second cleaning apparatus 22 on the second transport belt 2 can in each case have a brush which is preferably selected from a group which contains a conical brush, a spirally running brush, a roller brush, a round brush, a cup brush and a bevel brush. Additionally, the first and/or the second cleaning apparatus 21, 22 can have in each case at least two brushes which are arranged parallel or at an angle with respect to one another and are orientated parallel or at an angle to the running direction of the first or of the second transport belt.

Further, the first and the second cleaning apparatus 21, 22 in each case have an air flow unit which creates an air flow which conveys away the particles brushed from the electrode 10.

Furthermore, the two cleaning apparatuses 21, 22 can themselves be provided with discharge units for reducing the electrostatic charge of the respective brushes during the cleaning process of the electrodes 10.

Further, the cleaning system 50 can have a monitoring unit for monitoring and preferably optically monitoring the cleaned electrodes 10 on the third transport belt 3.

As indicated in FIG. 2, the electrodes 10 are arranged in such a manner on the first transport belt 1 and consequently also on the second transport belt 2 that the side surfaces thereof run obliquely to the running direction of the vacuum belts 1, 2, i.e. are orientated at an angle different from 0 degrees and from 90 degrees relatively to the running direction of the vacuum belts. Preferably, this angle lies in the range between approximately 30 and 45 degrees. In this manner, the side surfaces of the electrodes 10 can be better and more thoroughly cleaned by means of the brushes of the first and second cleaning apparatuses 21, 22.

On the basis of the flow diagram of FIG. 3, the method steps for cleaning the electrodes 10 with the above described cleaning system 50 are explained again.

In a step S1, the electrodes 10 are initially arranged on the first transport belt 1. In a step S2, the electrodes 10 are then moved with the first transport belt 1 to the first cleaning apparatus 21. In the region of the first cleaning apparatus 21, the electrodes 10 are in this case electrostatically discharged by means of the first discharge apparatus 13.

In a step S3, the electrodes 10 are then cleaned on the first transport belt 1 by means of the first cleaning apparatus 21. In this step S3, the electrodes 10 can be brushed on the first transport belt 1 using at least one rotating brush. Alternatively or additionally, the particles can also be loosened on the electrodes by means of an air knife or by means of ultrasonic pulses. Further, the loosened particles are conveyed away in the first cleaning apparatus 21 by means of an air flow.

In a step S4, the electrodes 10 are then handed over from the first transport belt 1 to the second transport belt 2. Due to the overlap of the two vacuum belts 1, 2 and the opposite orientation with opposite suction actions, the electrodes 10 are arranged with the upper side 11 thereof facing the second transport belt 2.

With the aid of the second transport belt 2, the electrodes are then moved in a step S5 to the second cleaning apparatus 22. In the region of this second cleaning apparatus 22, the electrodes 10 are electrostatically discharged on the second transport belt 2, preferably by means of the second discharge apparatus 14.

In a step S6, the electrodes 10 are then cleaned on the second transport belt 2 in the second cleaning apparatus 22. In this step S6, the electrodes 10 can be brushed on the second transport belt 2 using at least one rotating brush. Alternatively or additionally, the particles can also be loosened on the electrodes 10 by means of an air knife or by means of ultrasonic pulses. Further, the loosened particles are conveyed away in the second cleaning apparatus 22 by means of an air flow.

In a step S7, the electrodes 10 are subsequently handed over from the second transport belt 2 to the third transport belt 3. This handover takes place in reverse for a handover between the first and the second transport belt 1, 2. In a step S8, the electrodes 10 are finally guided further on the transport belt 3, wherein an investigation of the cleaned electrodes 10 can be carried out.

The FIGS. 4a to 4m show schematic illustrations for arrangements of the cleaning apparatuses with brushes and brush fillings with respect to the running direction and arrangements of the electrodes to be cleaned in accordance with various exemplary embodiments of the present invention, wherein the invention is not limited to the arrangements of these exemplary embodiments.

According to a first embodiment, which is shown in FIG. 4a, a brush 25 can be arranged perpendicularly to a transport device 5 of the electrode 10 to be cleaned and parallel to a side surface 15 of this electrode 10, wherein the brush rotates in a direction of rotation 6, the axis of rotation of which is parallel both to the side surface 15 and to a transport belt not shown in this figure, wherein the brush filling 30 is arranged on the shell surface of the brush 25. With the arrangement of the first embodiment, the side surface 15 and a side surface lying opposite this side surface and also the upper side of the electrode 10 can be cleaned particularly well.

According to a second embodiment, which is shown in FIG. 4b, the brush 25 can be arranged perpendicularly to the transport device 5 of the electrode 10 to be cleaned, wherein a first side surface 15a and a second side surface 15b of this electrode 10 can be arranged at an angle of approximately 45° to the brush 25 and the brush 25 rotates in the direction of rotation 6, the axis of rotation of which is both at an angle of approximately 45° to the first and the second side surface 15a and 15b and parallel to a transport belt not shown in this figure, wherein the brush filling 30 is arranged on the shell surface of the brush 25. With the arrangement of the second embodiment, both all four side surfaces 15a, 15b, 15c, 15d and also the upper side of the electrode 10 can be cleaned particularly well.

According to a third embodiment, which is shown in FIG. 4c, a first brush 26 and a second brush 27 can in each case be arranged at an angle of approximately 45° to the transport direction 5 of the electrode 10 to be cleaned, wherein the first side surface 15a of the electrode 10 can be arranged perpendicularly to the transport direction 5 and the second side surface 15b and a third side surface 15c of the electrode 10 can in each case be arranged parallel to the transport direction 5 and the first brush 26 rotates in one direction of rotation 7 and the second brush 27 rotates in a preferably opposite direction of rotation 8, the axes of rotation of which are arranged in each case both at approximately 45° to the transport direction 5 and parallel to a transport belt not shown in this figure, wherein the brush filling 30 is in each case arranged on the shell surfaces of the first brush 26 and the second brush 27. Also with the arrangement of the third embodiment, both all four side surfaces 15a, 15b, 15c, 15d and also the upper side of the electrode 10 can be cleaned particularly well.

According to a fourth embodiment, which is shown in FIG. 4d, the first brush 26 and the second brush 27 can in each case be arranged perpendicularly to the transport direction 5 of the electrode 10 to be cleaned and perpendicularly to a transport belt not shown in this figure, wherein the first side surface 15a and the second side surface 15b of the electrode 10 are arranged in each case at an angle of approximately 45° to the transport direction 5 and the first brush 26 rotates in one direction of rotation 7 and the second brush 27 rotates in a preferably opposite direction of rotation 8, the axes of rotation of which are arranged in each case perpendicularly to a transport belt not shown in this figure, wherein the brush filling 30 is in each case arranged on the base surfaces of the first brush 26 and the second brush 27. In this manner, the upper side of the electrode 10 can be cleaned particularly well.

According to a fifth embodiment, which is shown in FIG. 4e, the first brush 26 and the second brush 27 can in each case be arranged perpendicularly to the transport direction 5 of the electrode 10 to be cleaned and perpendicularly to a transport belt not shown in this figure, wherein the first side surface 15a and the second side surface 15b of the electrode 10 are arranged in each case at an angle of approximately 45° to the transport direction 5 and the first brush 26 rotates in the direction of rotation 7 and the second brush 27 rotates in the preferably opposite direction of rotation 8, the axes of rotation of which are arranged in each case perpendicularly to a transport belt not shown in this figure, wherein the brush filling 30 is in each case arranged on the shell surfaces of the first brush 26 and the second brush 27 and the first brush 26 and the second brush 27 are arranged movably with respect to one another in a relative movement direction 13 arranged essentially perpendicularly to the transport direction 5. All four side surfaces 15a, 15b, 15c, 15d can be cleaned particularly well due to the relative movement 13.

According to a sixth embodiment, which is shown in FIG. 4f, the first brush 26 and the second brush 27 can be arranged perpendicularly to the transport direction 5 of the electrode 10 to be cleaned, wherein the first side surface 15a and the second side surface 15b of this electrode 10 are arranged in each case at an angle of approximately 45° to the first brush 26 and the second brush 27 and the first brush 26 rotates in the direction of rotation 7 and the second brush 27 rotates in the preferably opposite direction of rotation 8, the axes of rotation of which are both arranged at an angle of approximately 45° to the first and the second side surfaces 15a and 15b and parallel to a transport belt not shown in this figure, wherein the brush filling 30 is arranged both on the shell surface of the first brush 26 and on the shell surface of the second brush 27. The cleaning of the electrode 10 can be improved due to the opposite directions of rotation 7 and 8 of the first brush 26 and the second brush 27.

According to a seventh embodiment, which is shown in FIG. 4g, the first brush 26 and the second brush 27 and also a third brush 28 can in each case be arranged perpendicularly to the transport direction 5 of the electrode 10 to be cleaned and perpendicularly to a transport belt not shown in this figure, wherein the first side surface 15a and the second side surface 15b of the electrode 10 are arranged in each case at an angle of approximately 45° to the transport direction 5 and the first brush 26 rotates in the direction of rotation 7 and the second brush 27 rotates in the preferably opposite direction of rotation 8, the axes of rotation of which are arranged in each case perpendicularly to a transport belt not shown in this figure, wherein the brush filling 30 is in each case arranged on the shell surfaces of the first brush 26 and the second brush 27 and the first brush 26 and the second brush 27 are arranged movably with respect to one another in a relative movement direction 13 arranged essentially perpendicularly to the transport direction 5, wherein the brush filling for the third brush 28 is arranged on the base surface thereof. The arrangement according to the seventh embodiment combines the advantages of the arrangements according to the fourth and the fifth embodiments, so that the four side surfaces 15a, 15b, 15c, 15d and the upper side of the electrode 10 can be cleaned particularly well.

According to an eighth embodiment, which is shown in FIG. 4h, the first brush 26 and the second brush 27 can be arranged perpendicularly to the transport direction 5 of the electrode 10 to be cleaned and parallel to the side surface 15 of the electrode 10, wherein the first brush 26 rotates in the direction of rotation 7 and the second brush 27 rotates in the preferably opposite direction of rotation 8, the axes of rotation of which are both parallel to the side surface 15 and to a transport belt not shown in this figure, wherein the brush filling 30 is in each case arranged on the shell surfaces of the first brush 26 and the second brush 27. Similarly to the sixth embodiment, in the eighth embodiment, the cleaning of the electrode 10 can be improved due to the opposite directions of rotation 7 and 8 of the first brush 26 and the second brush 27.

According to a ninth embodiment, which is shown in FIG. 4i, the first brush 26 and the second brush 27 can be arranged parallel to the transport direction 5 of the electrode 10 to be cleaned and perpendicularly to the side surface 15 of the electrode 10 and the third brush 28 and a fourth brush can be arranged perpendicularly to the transport direction 5 and parallel to the side surface 15 of the electrode 10, wherein the first brush 26 rotates in the direction of rotation 7 and the second brush 27 rotates in the preferably opposite direction of rotation 8, the axes of rotation of which are arranged perpendicular to the side surface 15 and parallel to a transport belt not shown in this figure, wherein the brush filling 30 is in each case arranged on the shell surfaces of the first brush 26 and the second brush 27, and wherein the third brush 28 rotates in the direction of rotation 9 and the fourth brush 29 rotates in a preferably opposite direction of rotation 14 to the direction of rotation 9, the axes of rotation of which are parallel both to the side surface 15 and to the transport belt not shown in this figure, and wherein the brush filling 30 is in each case arranged on the shell surfaces of the third brush 28 and the fourth brush 29. With the arrangement of the ninth embodiment, both the four side surfaces 15a, 15b, 15c, 15d and also the upper side of the electrode 10 can be cleaned particularly well.

According to a tenth embodiment, which is shown in FIG. 4j, the first brush 26 and the second brush 27 can be arranged parallel to the transport direction 5 of the electrode 10 to be cleaned and perpendicularly to the side surface 15 of the electrode 10, wherein the first brush 26 rotates in the direction of rotation 7 and the second brush 27 rotates in the preferably opposite direction of rotation 8, the axes of rotation of which are arranged perpendicular to the side surface 15 and parallel to a transport belt not shown in this figure, wherein the brush filling 30 is in each case arranged on the shell surfaces of the first brush 26 and the second brush 27. Furthermore, in the tenth embodiment, the brush filling is preferably arranged in a spiral manner on the first and the second brushes, as a result of which in addition to the cleaning of the side surface 15b, 15c, the transport of the electrode 10 to be cleaned is also supported.

In FIG. 4k, an eleventh embodiment is shown, in which the brush 25 with the direction of rotation 6 is arranged perpendicularly to the transport direction 5 and at an acute angle, preferably approximately 45° to the upper side 11 and the side surface 15 of the electrode 10, wherein the brush filling 30 is arranged on the shell surface of the brush 25. This arrangement of the eleventh exemplary embodiment can improve the cleaning of the side surface 15 and the upper side of the electrode 10.

In FIG. 4l, a twelfth embodiment is shown, in which the brush 25 with the direction of rotation 6 is arranged perpendicularly to the transport direction 5 and parallel to the side surface 15 of the electrode 10, wherein the brush filling 30 is arranged on the shell surface of the brush 25 and the brush 25 has a conical design.

In FIG. 4m, a thirteenth embodiment is shown, in which the brush 25 with the direction of rotation 6 is arranged perpendicularly to the transport direction 5 and at an acute angle, preferably approximately 45° to the upper side 11 and the side surface 15 of the electrode 10, wherein the brush filling 30 is preferably arranged on an annular ring on the outer circumference of the brush 25 in the manner of a cup.

### REFERENCE LIST

1 First transport belt
2 Second transport belt
3 Third transport belt
4 Monitoring unit
5 Transport direction of the object
6 Direction of rotation of a brush
7 Direction of rotation of a first brush
8 Direction of rotation of a second brush
9 Direction of rotation of a third brush
10 Object
11 First object side
12 Second object side
13 Relative movement direction of the first and second brushes
14 Direction of rotation of a fourth brush
15 Side surface to be cleaned
15a First side surface to be cleaned
15b Second side surface to be cleaned
15c Third side surface to be cleaned
15d Fourth side surface to be cleaned
21 First cleaning apparatus
22 Second cleaning apparatus
25 Brush
26 First brush
27 Second brush
28 Third brush
29 Fourth brush
30 Brush filling
50 Cleaning system

1-22. (canceled)

23. A method for cleaning sheet- or plate-shaped electrodes and/or separators for constructing an electrochemical energy storage or parts of such electrodes or separators, wherein the sheet- or plate-shaped electrodes and/or separators have a first object side and a second object side opposite the first object side and at least one side surface connecting the first and the second object sides, the method comprising the steps:
(S1) arranging at least the electrode and/or the separator on a first transport belt in such a manner that the second object side faces the first transport belt;
(S2) moving the electrode and/or the separator with the first transport belt to a first cleaning apparatus;
(S3) cleaning the first object side on the first transport belt by means of the first cleaning apparatus;
(S4) handing over the electrode and/or the separator from the first transport belt to a second transport belt in such a manner that the first object side faces the second transport belt;
(S5) moving the electrode and/or the separator with the second transport belt to a second cleaning apparatus; and
(S6) cleaning the second object side on the second transport belt by means of the second cleaning apparatus.

24. The method according to claim 23, wherein step (S3) includes cleaning at least one side surface of the electrode and/or the separator on the first transport belt by means of the first cleaning apparatus.

25. The method according to claim 23, wherein step (S6) includes cleaning at least one side surface of the electrode and/or the separator on the second transport belt by means of the second cleaning apparatus.

26. The method according to claim 23, wherein the object is arranged on the first and/or the second transport belt in such a manner that at least one side surface of the object is orientated at an angle different from 0 degrees and from 90 degrees.

27. The method according to claim 23, wherein the object is cleaned in a continuous method in step (S3) and/or in step (S6).

28. The method according to claim 23, wherein the first cleaning apparatus has a first brush apparatus and/or in that the second cleaning apparatus has a second brush apparatus.

29. The method according to claim 28, wherein the object is brushed in step (S3) and/or in step (S6) on the first or the second transport belt with at least one rotating brush for loosening adhering particles.

30. The method according to claim 23, wherein in step (S3) and/or in step (S6), particles are loosened from the object on the first or second transport belt by means of ultrasonic pulses.

31. The method according to claim 23, wherein in step (S3) and/or step in step (S6), the particles loosened from the object are conveyed away by means of an air flow.

32. The method according to claim 23, wherein the object is electrostatically discharged on the first transport belt and/or on the second transport belt.

33. The method according to claim 23, wherein, after step (S6) in a step (S7) the object is handed over from the second transport belt to a third transport belt, wherein the second object side faces the third transport belt.

34. The method according to claim 23, wherein in step (S4) and/or in step (S7) the object is handed over between the two transport belts with constant orientation relative to the running direction of the first or the second transport belt.

35. An apparatus for cleaning sheet- or plate-shaped electrodes and/or separators for constructing an electrochemical energy storage or parts of such electrodes or separators, wherein the electrodes and/or separators have a first object side and a second object side opposite the first object side and at least one side surface connecting the first and the second object sides, the apparatus comprising:
a first transport belt for moving the electrode and/or the separator to a first cleaning apparatus, wherein the first transport belt is arranged and configured in such a manner that it accommodates the electrode and/or the separator in such a manner that the second object side faces the first transport belt;
the first cleaning apparatus, which is arranged and configured in such a manner that it can clean the first object side and at least one side surface of the electrode and/or the separator on the first transport belt;
a second transport belt for handing over the electrode and/or the separator from the first transport belt and moving the electrode and/or the separator to a second cleaning apparatus, wherein the second transport belt is arranged and configured in such a manner that it accommodates the electrode and/or the separator in such a manner that the first object side faces the second transport belt; and
the second cleaning apparatus, which is arranged and configured in such a manner that it can clean the second object side and at least one side surface of the electrode and/or the separator on the second transport belt.

36. The apparatus according to claim 35, wherein the first cleaning apparatus has a first brush apparatus and/or in that the second cleaning apparatus has a second brush apparatus

37. The apparatus according to claim 35, wherein the first and/or the second cleaning apparatus have at least one rotating brush.

38. The apparatus according to claim 35, wherein the first and/or the second cleaning apparatus have at least one brush, which is selected from a group which contains conical brushes, spirally running brushes, roller brushes, round brushes, cup brushes and bevel brushes.

39. The apparatus according to claim 35, wherein the first and/or the second cleaning apparatus have at least two brushes which are arranged parallel or at an angle with respect to one another and are orientated parallel or at an angle to the running direction of the first or of the second transport belt.

40. The apparatus according to claim 35, wherein the first and/or the second cleaning apparatus have at least one ultrasonic unit for generating ultrasonic pulses directed onto the object.

41. The apparatus according to claim 35, wherein the first and/or the second cleaning apparatus have an air flow unit for generating an air flow for conveying away the particles loosened from the object.

42. The apparatus according to claim 35, wherein a suction direction of the first transport belt is chosen to be opposite to a suction direction of the second transport belt.

43. The apparatus according to claim 35, wherein the first transport belt and the second transport belt can be arranged such that the running directions thereof overlap one another.

44. The apparatus according to claim 35, wherein a first electrostatic discharge apparatus, which is arranged on the first transport belt and/or the first cleaning apparatus, and/or a second electrostatic discharge apparatus, which is arranged on the second transport belt and/or the second cleaning apparatus, are provided.

45. The apparatus according to claim 44, wherein the first and/or second electrostatic discharge apparatuses have a discharge functional unit which is selected from a group which contains a metal roller, a roller with conductive surface, a discharge rod and a curtain with electrically conductive constituents.

46. The apparatus according to claim 35, wherein at least one third transport belt is provided for handing over the object from the second transport belt.
